(19) United States
(12) Patent Application Publication
(10) Pub. No.: US 2012/0226829 A1
(43) Pub. Date: Sep. 6, 2012

(54) ELECTRONIC APPARATUS AND METHOD FOR CONTROLLING THE SAME

(75) Inventor: Hideaki Takahashi, Shizuoka-ken (JP)

(73) Assignee: TOSHIBA TEC KABUSHIKI KAISHA, Tokyo (JP)

(21) Appl. No.: 13/398,953

(22) Filed: Feb. 17, 2012

(30) Foreign Application Priority Data
Mar. 4, 2011 (JP) 2011-047185

(51) Int. Cl. G06F 3/00

(52) U.S. Cl. 710/10

(57) ABSTRACT

According to one embodiment, an electronic apparatus comprises at least one equipment connection port and a control unit configured to switch enabling and disabling the equipment connection port before and after an OS is started up.

### CROSS-REFERENCE TO RELATED APPLICATION

This application is based upon and claims the benefit of priority from Japanese Patent Application No. 2011-047185, filed Mar. 4, 2011, the entire contents of which are incorporated herein by reference.

### FIELD

Embodiments described herein relates to an electronic apparatus and an electronic apparatus control method.

### BACKGROUND

At present, when starting up an information processing apparatuses such as PC, the Universal Serial Bus (USB) port thereof is enabled or disabled according to the setting of a Basic Input/Output System (BIOS). Moreover, a Power On Self Test (POST) is executed during the startup process to detect whether or not there is a fault in a memory, HDD or USB port. The setting of the BIOS is reflected to the POST process when it is executed.

Generally, a keyboard is used to perform input on a BIOS setting screen to change the setting of the BIOS. On the other hand, in an information processing apparatus with no keyboard, such as a Point Of Sales (POS) device, which achieves an input operation via a touch panel, if there is a need to change the setting of a BIOS, an external keyboard is connected with the USB port of the information processing apparatus to realize an input operation.

### BRIEF DESCRIPTION OF THE DRAWINGS

FIG. 1 is a perspective view illustrating the appearance of the POS terminal of an embodiment;

FIG. 2 is a block diagram illustrating the structure of the print circuit board installed in a POS terminal;

FIG. 3 is a view showing an example of the BIOS setting data stored in a BIOSROM and related to USB ports;

FIG. 4 is a view showing an example of a BIOS setting screen related to USB ports;

FIG. 5 is a view showing an example of a setting selection screen for the selection of any one of a first to third settings;

FIG. 6 is a view showing a BIOS setting screen displayed after BIOS setting data is changed;

FIG. 7 is a flow chart illustrating the startup process of a POS terminal carried out by a CPU;

FIG. 8 is a diagram illustrating the state of each USB port before an Operating System (OS) is started up (before operating the startup process of the OS); and

FIG. 9 is a diagram illustrating the state of each USB port after an OS is started up (after operating the startup process of the OS)

### DETAILED DESCRIPTION

According to one embodiment, an electronic apparatus comprises at least one equipment connection port and a control unit configured to switch enabling and disabling the equipment connection port before and after an OS is started up.

In this embodiment, a case is illustrated in which a POS terminal 1 is used as an electronic apparatus. In addition, the electronic apparatus of this embodiment can be a settlement terminal and the like but is not limited to the POS terminal 1.

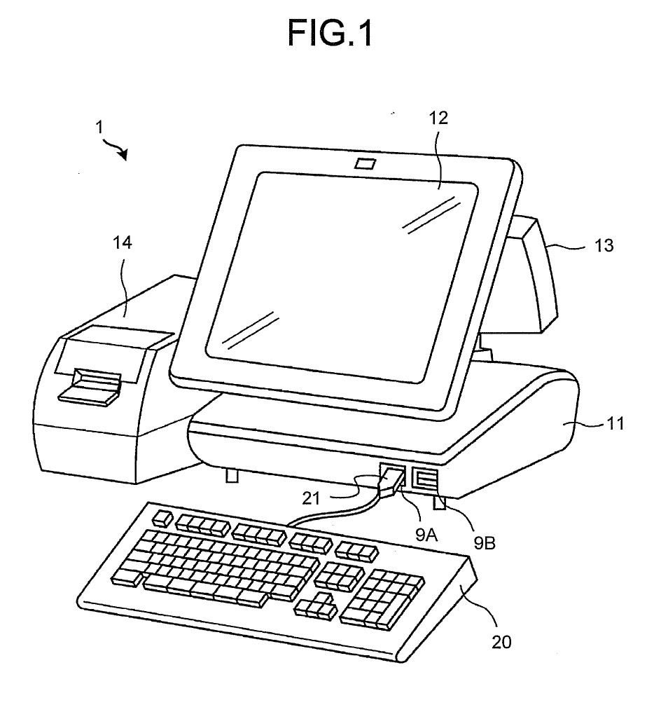

FIG. 1 is a perspective view illustrating the appearance of the POS terminal 1 of this embodiment. As shown in FIG. 1, the POS terminal 1 has a main body 11 in which a motherboard such as a print circuit board is accommodated and on which an operator-oriented display 12 and a customer-oriented display 13 are arranged. Moreover, a touch panel is arranged on the surface of the display 12 for a shop clerk to input an amount or select a commodity name displayed on the display 12. Moreover, a printer 14 is connected with the main body 11 via a connecting cable.

USB ports 9a, 9b are arranged on the front surface of the main body 11 as equipment connection ports. In the POS terminal 1, a USB connector 21 is connected with the USB port 9a or 9b to use a USB device 20. Besides, a keyboard shown in FIG. 1 or a USB memory (not shown) can be used as the USB device 20.

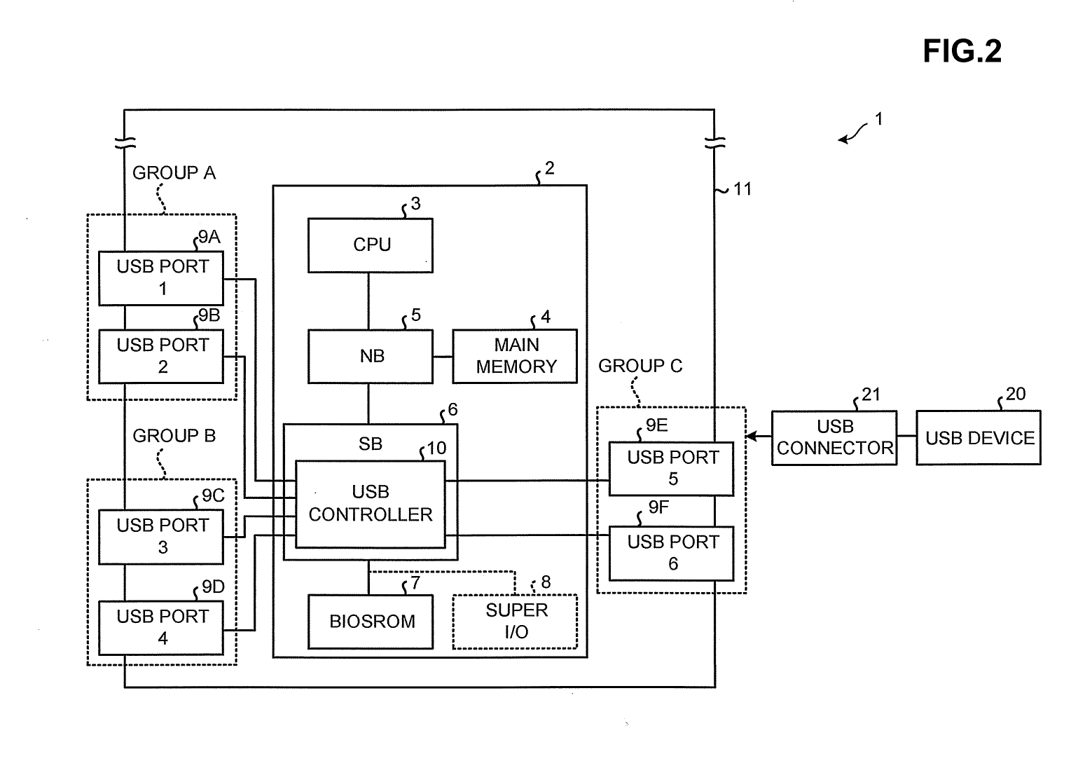

Next, the structure of the print circuit board 2 installed in the POS terminal 1 is described. FIG. 2 is a block diagram illustrating the structure of the print circuit board 2 installed in the POS terminal 1. As shown in FIG. 2, a CPU 3, a main memory 4 including an ROM or RAM, a North Bridge 5 (NB), a South Bridge (SB) 6 and a BIOSROM 7 are arranged on the print circuit board 2 and electrically connected with each other via a bus line or interfaces.

The setting data and the program package of BIOS are stored in the BIOSROM 7. In addition, a nonvolatile memory, for example, a rewritable flash ROM, is used as the BIOSROM 7.

The CPU 3 is a main processor which controls the overall POS terminal system serving as a control mechanism. The CPU 3 loads the BIOS program stored in the BIOSROM 7 into the main memory 4 and then executes the BIOS program. In addition, the CPU 3 loads the OS program or the application program stored in an HDD (not shown) or the ROM of the main memory 4 into the RAM of the main memory 4 and then executes the OS program or the application program.

The NB 5 is a bridge connector which connects the CPU 3, the main memory 4 and the SB 6 and in which a memory controller for controlling the read/write of the main memory 4 and a Peripheral Component Interconnect (PCI) primary device are built.

The SB6 has ports for connecting peripheral devices such as printer 14, displays 12, 13 and touch panel arranged in the display 12. The SB6, which is a bridge connector for connecting peripheral devices with the NB 5, is connected with the NB 5 via a PCI bus line. The PCI bus line is further connected with network interfaces. Moreover, the SB 6 is also connected with the BIOSROM 7 via a Low Pin Count (LPC) bus line.

The SB 6, which serves as a controller for controlling the peripheral devices connected therewith, has a USB controller 10 which serves as a part of functions of the SB 6. Besides, as shown by the dotted line shown in FIG. 1, the SB 6 may be connected with a Super I/O 8 via the LPC bus line. And in this case, the Super I/O 8 may also include a function of the USB controller 10.

USB ports 1-6 (9a, 9b, 9c, 9d, 9e, 9f) are connected with the USB controller 10.

In the case where a BIOS setting enables the USB port 5 (9e), if a USB connector 21 is connected with the USB port 5 (9e), as shown in FIG. 2, then the CPU 3 identifies the USB device 20 through the USB controller 10 and the USB port 5 (9e) and performs input/output of data to or from the USB device 20.

On the other hand, in the case where a BIOS setting disables the USB port 5 (9e), the CPU 3 is unable to identify the USB device and thus does not perform input/output of data to or from the USB device 20 even if the USB connector 21 is connected with the USB port 5 (9e).

Moreover, as shown in FIG. 2, the USB ports 1-6 (9a-9e) are divided into three groups: group A (USB ports 1 and 2), group B (USB ports 3 and 4) and group C (USB ports 5 and 6), each group of which is enabled or disabled correspondingly.

Next, the BIOS setting data, stored in the BIOSROM 7, which relates to USB ports is explained.

In the BIOSROM 7, the BIOS setting related to USB ports refer to any one of:

(1) a first setting (always enabled) which sets the USB ports to be enabled, regardless of whether or not an OS is started up;

(2) a second setting (always disabled) which sets the USB ports to be disabled, regardless of whether or not an OS is started up; and

(3) a third setting (enabled until an OS is started up) which sets the USB ports to be enabled before the OS is started up and disabled after the OS is started up.

The three settings are stored in association with the groups A, B, or C, respectively.

The BIOSROM 7 can also store any one of the first to third settings in association with USB ports and enable or disable corresponding USB ports respectively. That is, chip sets serving as a USB controller 10 are classified into two types: type 1: a chip set controls USB ports respectively, and type 2: a chip set controls all the USB ports together. Accordingly, the USB ports are enabled or disabled according to the type of the chip set to be used.

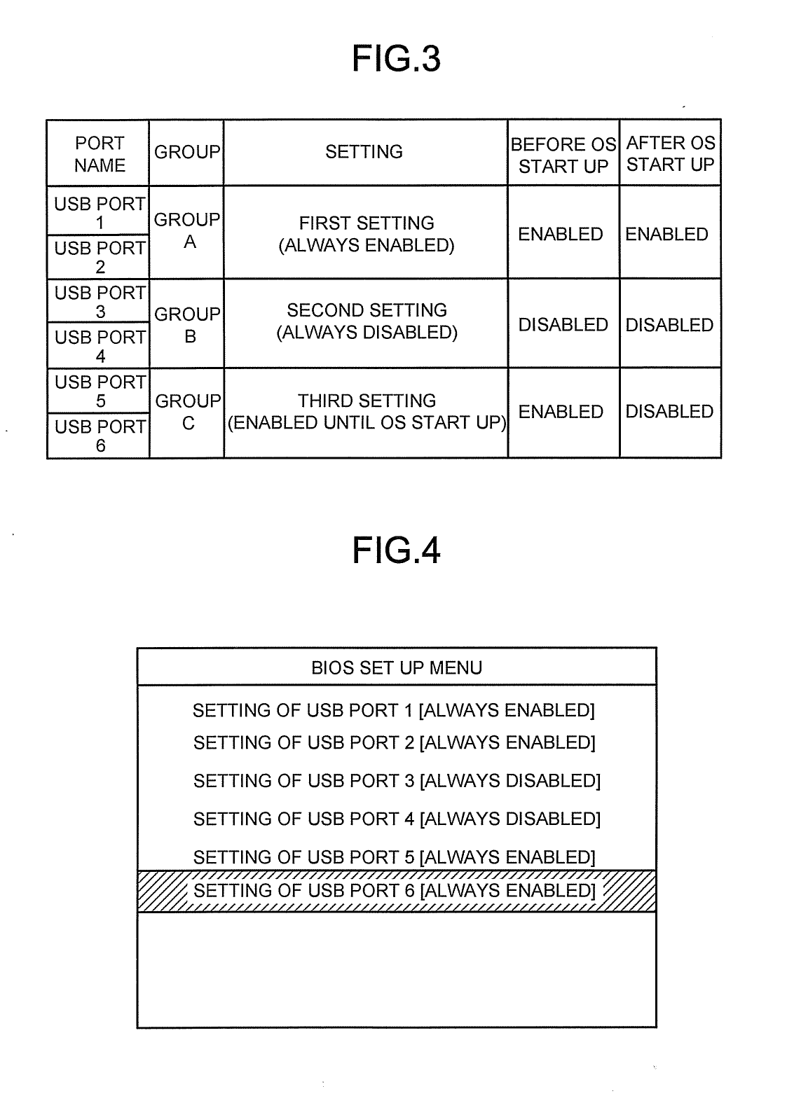

FIG. 3 is a view showing an example of the BIOS setting data stored in a BIOSROM and related to USB ports. In the example shown in FIG. 3, a first setting is stored for the group A so that the USB ports 1 and 2 of the group A are enabled before and after an OS is started up. A second setting is stored for the group B so that the USB ports 3 and 4 of the group B are disabled before and after an OS is started up. A third setting is stored for the group C so that the USB ports 5 and 6 of the group C are enabled before an OS is started up and disabled after the OS is started up.

Next, a method for changing the BIOS setting data related to USB ports is described. The BIOS setting data related to USB ports can be changed in a BIOS setting screen. Generally, a BIOS setting screen (referring to FIG. 4) can be displayed once a specified key (such as key F1 or F2) on a keyboard is pressed down within a given period following the startup of the POS terminal 1 to change the setting of a BIOS. As an example, the CPU 3 reads out a BIOS program from the BIOSROM 7 to display a BIOS setting screen on the display 12 if a specified key on a keyboard is pressed down during the POST process carried out within a given period following the startup of the POS terminal 1.

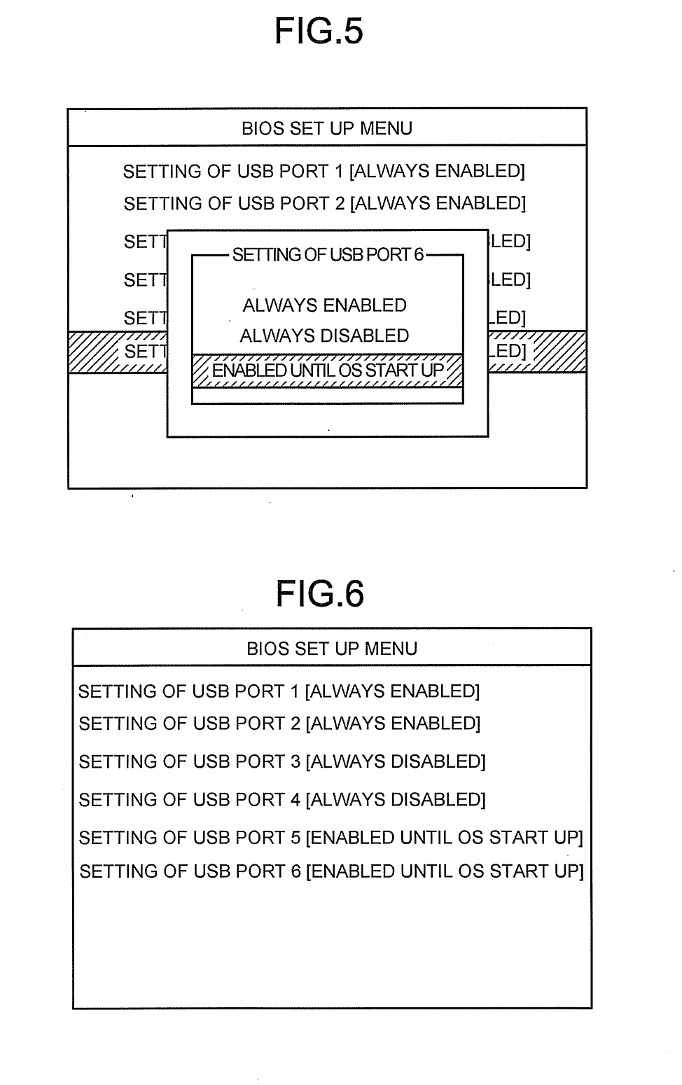

FIG. 4 is a view illustrating an example of a BIOS setting screen related to USB ports. In FIG. 4, the USB ports 1 and 2 are set to the first setting ‘always enabled’, the USB ports 3 and 4 are set to the second setting ‘always disabled’, and the USB ports 5 and 6 are set to the first setting ‘always enabled’. Below is description in which the USP ports 5 and 6 of the group C are changed to the third setting ‘maintained in an enabled state until the OS is started up’. The CPU 3 displays the selection screen shown in FIG. 5 in the case where the column corresponding to the USB port 6 is selected.

FIG. 5 is a view showing an example of a setting selection screen for the selection of any one of the first to third settings. The user selects any one of the first to third settings in the selection screen to change the setting of a USB port. FIG. 5 shows a selection of the third setting ‘maintained in an enabled state until the OS is started up’ for the USB port 6. As stated above, USB ports 5 and 6 belonging to the group C are controlled by the same setting, therefore, if the third setting is selected for the USB port 6, the same setting is also set for the USB port 5. Therefore, in the case where the setting is changed, the CPU 3 stores the content ‘the USB ports 5 and 6 are changed to the third setting’ in the BIOSROM 7 (referring to FIG. 3).

FIG. 6 shows is a view illustrating a BIOS setting screen displayed after BIOS setting data is changed. As shown in FIG. 6, the content that the USB ports 5 and 6 are changed to the third setting ‘maintained in an enabled state until the OS is started up’ is displayed in the BIOS setting screen.

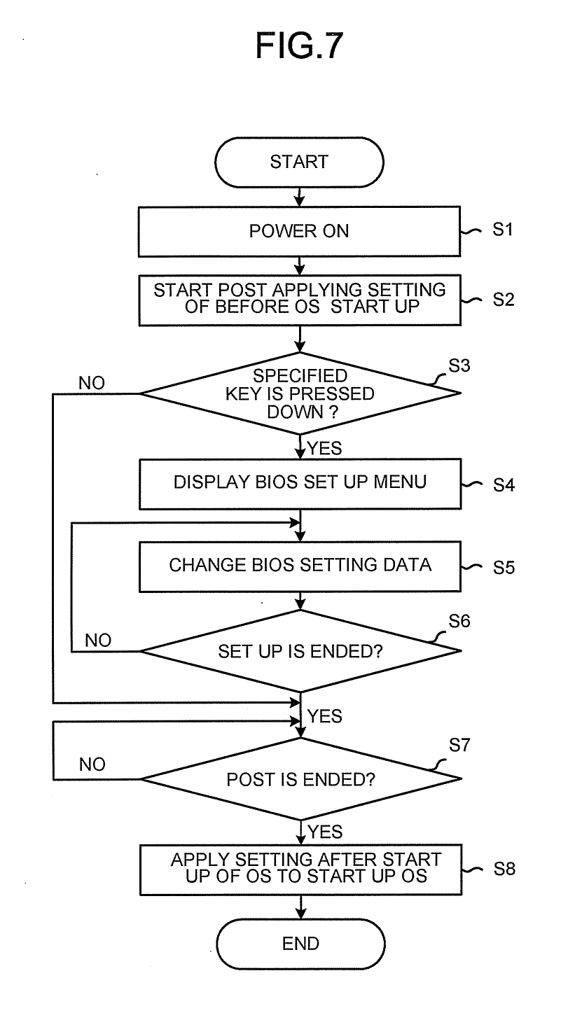

Next, the startup of the POS terminal 1 and the switching of USB ports between an enabled state and a disabled state carried out by the CPU 3 are described. FIG. 7 is a flow chart illustrating the startup process of the POS terminal 1 carried out by the CPU 3.

The following case is illustrated in FIG. 7 in which a USB port is enabled before an OS is started up and is disabled at a timing at which the OS is started up.

However, it should be appreciated that the timing for switching a USB port between an enabled state and a disabled state is not limited to the startup of an OS. The switching timing can also be the timing that the startup of the OS is ended. In this case, the USB port is maintained in an enabled state until the startup of the OS is ended and disabled after the startup of the OS is ended. Certainly, other timings can also be taken as a switching timing.

When the POS terminal 1 is powered ON (Act S1), the CPU 3 starts starting up of the POS terminal 1. That is, the CPU 3 reads the BIOS setting data stored in the BIOSROM 7 and applies the setting data to the peripheral devices connected with the SB 6. The CPU 3 then executes the POST process to check whether or not there is a fault in the peripheral devices. In this case, the CPU 3 starts the POST process, using the setting (before beginning the startup process of the OS) in the BIOS setting data related to the USB ports shown in FIG. 3 (Act S2)

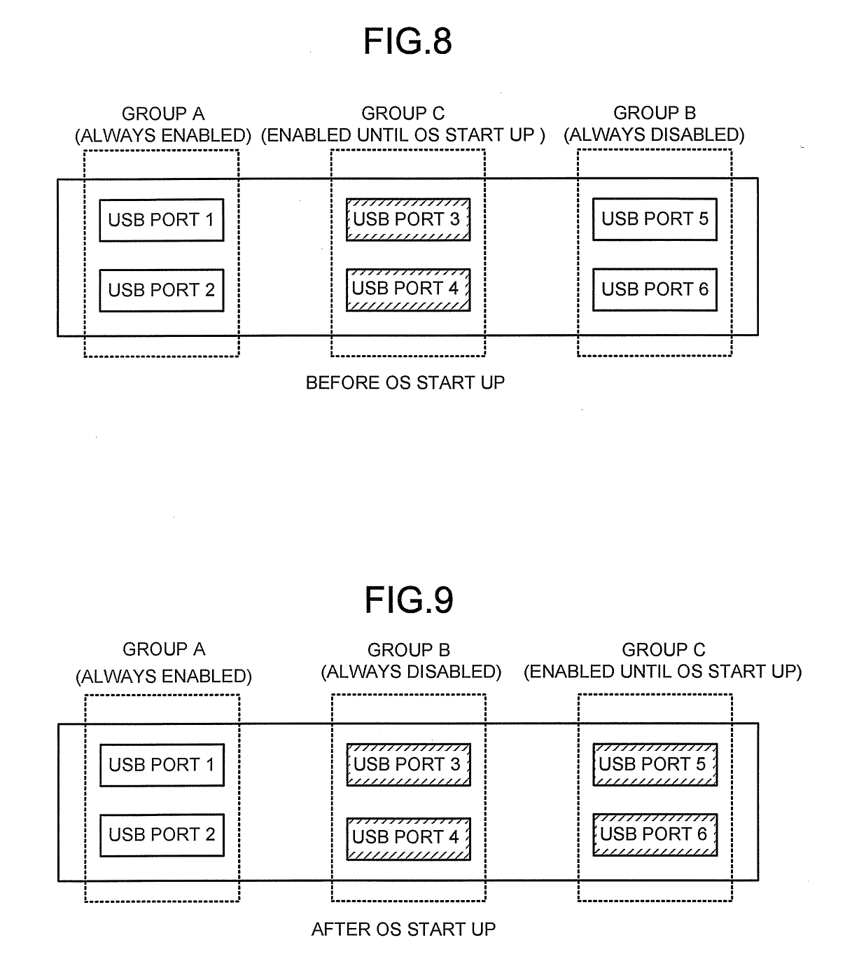

Thus, if the BIOS setting data is the setting content shown in FIG. 3, then each USB port is in the state shown in FIG. 8 during the execution period of Acts S2-S7. FIG. 8 is a diagram illustrating the state of each USB port before an OS is started up (before beginning the startup process of the OS). As shown in FIG. 8, the USB ports 1 and 2 of group A are enabled (white background), the USB ports 3 and 4 of group B are disabled (black background), and the USB ports 5 and 6 of group C are enabled (white background).

Next, the CPU 3 determines whether or not a specified key on the keyboard (the USB device 20 shown in FIG. 1) connected via the USB connector 21 is pressed down (Act S3)

If the specified key is pressed down (Act S3: Yes), the CPU 3 displays a BIOS setting screen (referring to FIG. 4) (Act S4). Then, the BIOS setting data is changed (Act S5), and a determination is made on whether or not the setting of the BIOS is ended (Act S6). If the setting of the BIOS is not ended (Act S6: No), the flow returns to Act S5 to continue to change the BIOS setting data. When the setting is ended and the display of the setting screen is terminated (Act S6: Yes), the flow returns to Act S7 to wait for the end of the POST precess (Act S7: No).

The CPU 3 starts starting up the OS after the POST process is ended (Act S7: Yes). In this case, the CPU 3 starts the OS using the setting (after the startup of the OS) in the BIOS setting data related to the USB ports shown in FIG. 3 (Act S8).

Thus, if the BIOS setting data is the setting content shown in FIG. 3, then each USB port is in the state shown in FIG. 9 after the execution of Act S8. FIG. 9 is a diagram illustrating the state of each USB port after an OS is started up (after beginning the startup process of the OS). As shown in FIG. 9, the USB ports 1 and 2 of group A are enabled (white background), the USB ports 3 and 4 of group B are disabled (black background), and the USB ports 5 and 6 of group C are disabled (black background).

As a result, the USB ports 5 and 6 of group C are switched to be in a disabled state from an enabled state based on the BIOS setting data shown in FIG. 3 at the timing that the OS is started up. Consequentially, the USB ports 5 and 6 of group C are enabled before the OS is started up and thus a USB device 20 such as a keyboard can be used on the one hand, and the USB ports 5 and 6 are disabled after the OS is started up and thus the USB device 20 is unidentified and cannot be used on the other hand.

As indicated by the description above, according to the POS terminal 1 of this embodiment, a USB port is maintained in an enabled state until the OS is started up.

Moreover, in the description above, an example is illustrated in which a USB port is maintained in an enabled state until the OS is started up and disabled after the OS is started up, however, it should be appreciated that the switching method is not limited to this mentioned here. As another example, the USB port can be maintained in a disabled state until the OS is started up and enabled after the OS is started up.

Moreover, the BIOS program executed in the POS terminal 1 in this embodiment is pre-programmed in the BIOSROM 7. The BIOS program may be stored in and provided by computer-readable storage mediums such as CD-ROM, floppy disk (FD), CD-R and digital versatile disk (DVD) as an installable or executable file.

Moreover, the BIOS program executed in the POS terminal 1 in this embodiment can also be stored in a computer connected with a network such as the Internet and loaded from the network to be used. The BIOS program executed in the POS terminal 1 in this embodiment can also be provided or published by networks such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus, comprising:
at least one equipment connection port; and
a control unit configured to switch enabling and disabling the equipment connection port before and after an OS is started up.

2. The electronic apparatus according to claim 1, wherein
the control unit enables the equipment connection port before the OS is started up and disables the equipment connection port after the OS is started up.

3. The electronic apparatus according to claim 2, further comprising:
a storage unit configured to store a first setting by which an equipment connection port is enabled regardless whether or not the OS is started up, a second setting by which an equipment connection port is disabled regardless whether or not the OS is started up and a third setting by which an equipment connection port is enabled before the OS is started up and is disabled after the OS is started up in a manner in which any one of the first, second and third settings is associated with each equipment connection port, wherein
the control unit controls each equipment connection port based on the respective settings stored in the storage unit related to each equipment connection port.

4. The electronic apparatus according to claim 3, further comprising:
a selection unit configured to select any one of the first setting, the second setting and the third setting as a setting of each equipment connection port; wherein
the storage unit stores the setting selected by the selection unit in association with each equipment connection port.

5. An electronic apparatus control method in the electronic apparatus having at least one equipment connection port, comprising:
switching enabling and disabling the equipment connection port before and after an OS is started up.
